(19) United States
(12) Patent Application Publication
(10) Pub. No.: US 2004/0184110 A1
(43) Pub. Date: Sep. 23, 2004

(54) Facsimile apparatus

(75) Inventors: Yoshihiro Maei, Iwatsuki-shi (JP); Kazutaka Saitoh, Iwatsuki-shi (JP); Yoshiharu Sagiya, Iwatsuki-shi (JP); Hirotaka Kawabata, Iwatsuki-shi (JP); Hideki Fujii, Iwatsuki-shi (JP)

Correspondence Address: OLIFF & BERRIDGE, PLC, P.O. BOX 19928, ALEXANDRIA, VA, 22320, US

(73) Assignee: Fuji Xerox Co., Ltd., Minato-ku (JP)

(21) Appl. No.: 10/657,262

(22) Filed: Sep. 9, 2003

(30) Foreign Application Priority Data
Mar. 18, 2003 (JP) 2003-073753

(51) Int. Cl. H04N 1/00; H04N 1/32; G06F 15/00

(52) U.S. Cl. 358/400; 358/442; 358/1.15

(57) ABSTRACT

A virtual voice mode facsimile communication unit, comprised of a TCP/UDP/IP control section which controls an IP protocol and a TCP/UDP protocol, a real-time transfer control section which controls a real-time transfer protocol, a voice encoding/decoding section which encodes/decodes a voice signal, a MODEM which modulates/demodulates assuming that a facsimile signal is a voice signal, a T30 control section which controls a T.30 facsimile protocol and a communication image processing section which conducts image processing of communication image data, is provide for real-time facsimile communications with a conventional facsimile apparatus over an IP network in a state kept connected to a LAN via a network I/F.

### BACKGROUND OF THE INVENTION

1. Field of the Invention

The present invention relates to a facsimile apparatus for conducting facsimile communications over IP (Internet Protocol) networks, and more particularly a facsimile apparatus having a virtual voice-mode facsimile communication unit which processes a facsimile signal assuming that it is a voice signal.

2. Description of the Related Art

Internet facsimile apparatuses (Internet FAX) which are connected to the IP network and conduct facsimile communications on the Internet are now in widespread use.

For example, the facsimile communications over the IP network are realized by the following methods.

\mathring{1} ITU-T T.37 mode (store and forward mode) for transfer of a TIFF-FX file which defines a facsimile image by e-mail according to SMTP.

\mathring{2} ITU-T T.38 mode (real-time transfer mode) for real-time transfer of a facsimile signal (including image information) on an IP packet by using a protocol called IFP (Internet Facsimile Protocol). For a session according to this mode, a peer-to-peer (P-t-P) connection is conducted by H.323 or SIP technology in the same way as an Internet telephone to be described later.

\mathring{3} Mode using IPP such as IPP FAX.

As the Internet FAX adopting the above-described communication modes, the following documents 1 to 5 are known.

Document 1 (Japanese Patent Application Laid-Open No. 11-298708) discloses a technology which has a conventional G3 control section and a LAN control section, detects communication capability of the destination Internet FAX by a conventional G3 FAX procedure, suspends the G3 FAX procedure and shifts to an appropriate Internet FAX.

Document 2 (Japanese Patent Application Laid-Open No. 2000-115503) discloses a technology which has a conventional G3 control section and a LAN control section and omits a T.38 mode procedure so to shorten the communication time.

Document 3 (Japanese Patent Application Laid-Open No. 2001-197279) discloses a technology which has a conventional G3 control section and a LAN control section, and voluntarily changes the number of redundant packets during communications in the T.38 mode using a UDP.

Document 4 (Japanese Patent Application Laid-Open No. 2002-44357) discloses a technology which has a communication unit in a conventional G3 mode, a T.37 mode and a T.38 mode and selects a mode according to priority to connect to the Internet via a public line network so to realize the conventional FAX transmission on the same line.

Document 5 (Japanese Patent Application Laid-Open No. 2002-44363) discloses a technology which has a configuration for connecting to the Internet via a public line network (PSTN: Public Switched Telephone Network) and a LAN control section containing a T.38/T.37 mode independent of the PSTN, and when the ability of the other end is known, conducts communications in the T.37 mode, and when it is not known, conducts communications in the T.38 mode.

Specifically, the above-described known Internet FAXes relate to a configuration for selecting any of the above modes, and there are disclosed the configurations (Documents 1, 2, 3) for shifting to the Internet FAX (T.37 mode or T.38 mode) according to a result of the call originated from the conventional G3 FAX through the public line, the configuration (Document 4) for connecting from a conventional G3 FAX to the Internet via the public lines, and the configuration (Document 5) having a function to connect from a conventional G3 FAX to the public line and a function to connect to the Internet in the T.37 mode or T.38 mode.

Meanwhile, the Internet telephony is becoming common as one of services provided over an internet line.

The Internet telephony is based on a technology which is called VoIP (Voice over IP) for sending and receiving voice data over the TCP/IP network (Internet).

With the widespread use of the Internet telephones as a backdrop, virtual voice-mode facsimile communications for real-time communications over the Internet with a facsimile signal assumed as a voice signal are being tried.

As a method of realizing the virtual voice-mode facsimile communications, it was heretofore common to configure that, for example, a dedicated adapter or an IP telephone terminal having an adapter function is connected to, for example, a conventional G3 FAX, the adapter or the IP telephone terminal receives a facsimile signal from the outside (FAX body) to configure an IP packet.

In this case, the adapter or the IP telephone terminal is required, and the cost of it is added to increase the equipment cost, and the configuration becomes complex.

Thus, the conventional Internet FAX has the adapter or the IP telephone terminal having an adapter function externally connected, the VoIP function of the equipment is used to realize virtual voice-mode facsimile communications.

Such a conventional Internet FAX has disadvantages that the equipment cost becomes high for the IP telephone terminal or the dedicated adapter and the configuration becomes complex.

The present invention is to provide a facsimile apparatus, which remedies the above disadvantages and the necessity of external connection of the adapter or the IP telephone terminal, can realize virtual voice-mode facsimile communications in a state connected to a LAN, and can reduce the equipment cost and simplify the configuration.

### SUMMARY OF THE INVENTION

The present invention has been made in view of the above circumstances and provides a facsimile apparatus for facsimile communications over an IP network, comprising: a network interface that connects to the IP network via a LAN or a public line; a TCP/UDP/IP protocol control unit that is connected to the network interface and controls an IP protocol and a TCP/UDP protocol; a real-time transfer protocol control unit that is connected to the TCP/UDP/IP protocol control unit and controls a real-time transfer protocol; a voice encoding/decoding unit that is connected to the real-time transfer protocol control unit and encodes and decodes a voice signal; a facsimile modem that is connected to the voice encoding/decoding unit and modulates and demodulates a facsimile signal; a first T30 protocol control unit that is connected to the facsimile modem and controls a T.30 facsimile protocol; a first communication image processing unit that is connected to the first T30 protocol control unit and conducts image processing of communication image data; and an image storage unit that is connected to the communication image processing unit and stores a read image or image data received from a network; wherein: real-time facsimile communications of a virtual voice-mode are conducted with a conventional facsimile apparatus via the IP network.

According to the present invention, the communication unit, which is comprised of the TCP/UDP/IP protocol control unit, the real-time transfer protocol control unit, the voice encoding/decoding unit, the facsimile modem, the facsimile protocol control unit and the communication image processing unit, and performs facsimile communications assuming that a facsimile signal is a voice signal, is disposed. Therefore, it is not necessary to externally connect an adapter or an IP telephone terminal having adapter functions, and virtual voice-mode real-time facsimile communications can be conducted with a conventional facsimile apparatus in a state connected to a LAN.

### BRIEF DESCRIPTION OF THE DRAWINGS

Preferred embodiments of the present invention will be described in detail based on the following figures, wherein:

FIG. 1 is a block diagram showing a functional configuration of the facsimile apparatus according to a first embodiment;

FIG. 2 is a diagram showing a configuration of the network on which the facsimile apparatus according to the first embodiment is disposed;

FIG. 3 is a flow chart showing a processing operation of the facsimile apparatus according to the first embodiment;

FIG. 4 is a block diagram showing a functional configuration of the facsimile apparatus according to a second embodiment;

FIG. 5 is a block diagram showing a functional configuration of the facsimile apparatus according to a third embodiment;

FIG. 6 is a diagram showing a configuration of the network on which the facsimile apparatus according to the third embodiment is disposed;

FIG. 7 is a diagram showing a configuration of the IP network terminal registration table according to the third embodiment;

FIG. 8 is a flow chart showing a processing operation of the facsimile apparatus according to the third embodiment; and

FIG. 9 is a block diagram showing a functional configuration of the facsimile apparatus according to a fourth embodiment.

### DESCRIPTION OF THE PREFERRED EMBODIMENTS

Embodiments of the invention will be described in detail with reference to the accompanying drawings.

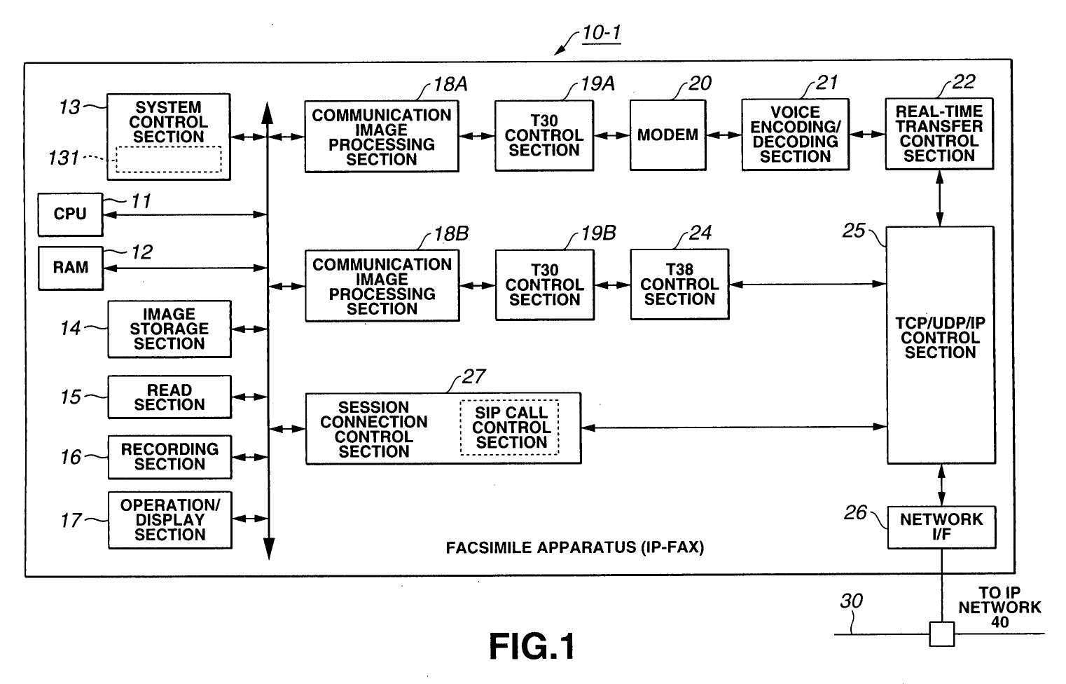

FIG. 1 is a block diagram showing a functional configuration of facsimile apparatus 10-1 according to the first embodiment of the invention.

This facsimile apparatus 10-1 is comprised of central processing unit (CPU) 11 for controlling the entire equipment; RAM 12 which becomes a work area (to store system data and a variety of information for controlling the operation of the equipment) used for a control program; system control section 13 having a program (ROM) for controlling the entire facsimile; image storage section 14 for storing image data received from a network or image data read; read section 15 for reading a sending original or a copying original at prescribed resolution; recording section 16 for recording and outputting the received image data or read image data on recording paper at prescribed resolution; operation/display section 17 which is comprised of a touch-sensitive panel or the like, operated by a user in various ways (calling operation etc.) to operate the equipment and to show a variety of information; communication image processing sections 18A, 18B for conducting processing such as resolution change, paper size change, code rule change or the like of the image data according to the ability of the other end when the image data is sent; T30 control sections 19A, 19B for controlling T.30 facsimile protocols according to the ITU-T recommendation; facsimile modem (MODEM) 20 which assumes a facsimile signal as a voice signal and modulates/demodulates the voice signal; voice encoding/decoding section 21 which encodes/decodes a virtual voice signal (facsimile signal) by a method such as a PCM (Pulse Code Modulation) or an ADPCM (Adaptive Differential Pulse Code Modulation); real-time transfer control section 22 which controls real-time transfer protocols such as an RTP (Real-time Transport Protocol); T38 control section 24 which controls T.38 protocols according to the ITU-T recommendation (for a real-time facsimile); TCP/UDP/IP control section 25 which controls protocols [IP protocol/TCP (Transmission Control Protocol)/UDP (User Datagram Protocol) protocol for controlling communications with the IP network] of a network layer/transport layer of the Internet; network interface (network I/F) 26 which has a communication control function for the data link layer or below and connects to the IP network over a LAN (Local Area Network) or a public line; and session connection control section 27 which has functions for controlling H.323 and SIP (Session Initiation Protocol) protocols and the session connection by the P-t-P over the Internet.

In the facsimile apparatus 10-1, the portion comprising the communication image processing section 18A, the T30 control section 19A, the MODEM 20, the voce encoding/decoding section 21, the real-time transfer control section 22 and the TCP/UDP/IP control section 25 configures a first communication unit.

The potion comprising the communication image processing section 18B, the T30 control section 19B, the T38 control section 24 and the TCP/UDP/IP control section 25 configures a second communication unit.

The first communication unit is used when a facsimile signal is assumed as a voice signal and real-time facsimile communications are conducted. In this case, the VoIP technology is used to perform signal processing to put the G3 facsimile communication procedure as it is on IP network 40.

When the virtual voice-mode first communication unit is selected to call a destination terminal so to establish a session with the destination terminal under control by the session connection control section 27 and to send image data to the destination terminal according to the G3 facsimile communication procedure, sending image data stored in the image storage section 14 is sent to the communication image processing section 18A.

The sending image data stored in the image storage section 14 is, for example, image data which is read by original-reading scanning performed by the read section 15 at the time of sending or image data which is previously received over the IP network.

The communication image processing section 18A performs processing such as a resolution change, a paper size change, a code rule change or the like on the image data from the image storage section 14 in accordance with the destination terminal capability and sends to the T30 control section 19A.

The T30 control section 19A sends the image data received from the communication image processing section 18A to the MODEM 20 according to the T.30 protocol.

The MODEM 20 modulates the image data (digital signal) received from the T30 control section 19A and sends the modulated signal (analog signal) to the voice encoding/decoding section 21.

The voice encoding/decoding section 21 encodes the modified signal (facsimile signal assumed to be a voice signal) received from the MODEM 20 by the encoding method such as the PCM and sends the encoded signal (digital signal) to the real-time transfer control section 22.

Upon receiving the encoded signal (virtual voice signal) from the voice encoding/decoding section 21, the real-time transfer control section 22 uses the real-time transfer protocol (RTP) to put it on an IP packet and sends to the TCP/UDP/IP control section 25.

The TCP/UDP/IP control section 25 puts the IP packet received from the real-time transfer control section 22 on the protocol such as TCP or UDP and sends to the IP network 40 over the network I/F 26.

When the image data is received within the first communication unit, the TCP/UDP/IP control section 25 receives over the network I/F 26 the IP packet [carrying a PCM encoded signal (virtual voice signal)] which is put on the protocol such as TCP or UDP and sent from the destination terminal over the IP network 40.

Then, the TCP/UDP/IP control section 25 uses the RTP to send the IP packet to the real-time transfer control section 22.

The real-time transfer control section 22 decomposes the IP packet received from the TCP/UDP/IP control section 25 to take the encoded signal (virtual voice signal) according to the PCM method or the like and sends to the voice encoding/decoding section 21.

The voice encoding/decoding section 21 decodes the encoded signal received from the real-time transfer control section 22 by the pertinent decoding method and sends to the MODEM 20.

The MODEM 20 demodulates the decoded signal (virtual voice signal: analog signal) received from the voice encoding/decoding section 21 into image data (digital signal) and sends to the T30 control section 19A.

The T30 control section 19A sends the demodulated signal (image data) received from the MODEM 20 to the communication image processing section 18A according to a T.30 protocol.

The communication image processing section 18A stores the image data received from the T30 control section 19A into the image storage section 14.

The image data stored in the image storage section 14 is sent to the recording section 16 for recording and discharging.

Meanwhile, the second communication unit is used to conduct facsimile communications in real time by using a T.38 protocol. In this case, signal processing is performed to put the facsimile signal containing image data on the T.38 packet (IP packet) so to relay within the IP network 40.

To send the image data to the destination terminal via the IP network 40 by establishing the session with the destination terminal under control by the session connection control section 27 after selecting the second communication unit according to the T.38 mode to call the destination terminal, the sending image data stored in the image storage section 14 is sent to the communication image processing section 18B.

The communication image processing section 18B conducts a resolution change, a paper size change, a code rule change or the like on the image data being received from the image storage section 14, depending on the destination terminal's capability and sends to the T30 control section 19B.

The T30 control section 19B sends out the image data received from the communication image processing section 18B to the T3 8 control section 24 according to the T.30 protocol.

Upon receiving the image data from the T30 control section 19B, the T38 control section 24 uses the IFP (Internet Facsimile Protocol) according to the T.38 Recommendation to put it on the IP packet and sends to the TCP/UDP/IP control section 25.

The TCP/UDP/IP control section 25 puts the IP packet received from the T38 control section 24 on the TCP or UDP protocol to send to the IP network 40 over the network I/F 26.

In the second communication unit, to receive the image data, the TCP/UDP/IP control section 25 receives the IP packet, which is put on the TCP or UDP protocol and sent from the destination terminal over the IP network 40, via the network I/F 26.

The TCP/UDP/IP control section 25 uses the IP to send the IP packet to the T38 control section 24.

The T38 control section 24 takes image data from the IP packet received from the TCP/UDP/IP control section 25 and sends it to the T30 control section 19B.

The T30 control section 19B sends the image data received from the T38 control section 24 to the communication image processing section 18B according to the T.30 protocol.

The communication image processing section 18B stores the image data received from the T30 control section 19B into the image storage section 14.

The image data stored in the image storage section 14 is sent to the recording section 16 for recording and discharging.

In the facsimile apparatus 10-1 configured as described above, the system control section 13 is provided with a communication unit selection control function for selecting either of the first and second communication units to call a destination terminal.

In the facsimile apparatus 10-1, use of either of the first or second communication unit for communications must be decided with the understanding of the network environment where the facsimile apparatus 10⁻¹ is used.

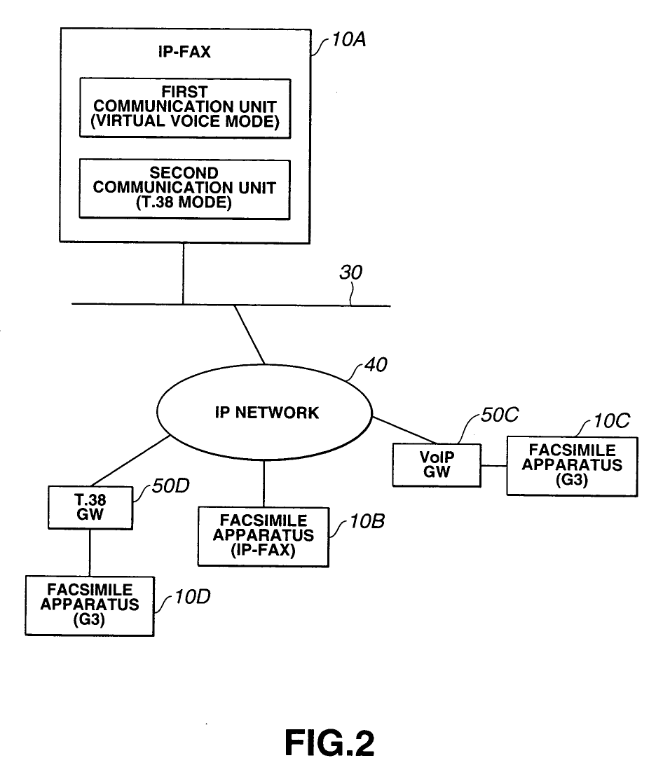

FIG. 2 is a diagram showing a configuration of the network where the facsimile apparatus 10-1 is disposed.

In FIG. 2, facsimile apparatus 10A (Internet FAX: IP-FAX) corresponds to the facsimile apparatus 10-1 shown in FIG. 1.

This facsimile apparatus 10A is connected to the IP network 40 over LAN 30.

Facsimile apparatus 10B (IP-FAX) having the same function as that of the facsimile apparatus 10A is connected to the IP network 40.

Conventional (G3) facsimile apparatus 10C is connected to the IP network 40 via gateway (VoIP GW) 50C based on the VoIP technology.

And, conventional (G3) facsimile apparatus 10D is connected to the IP network 40 via gateway (T.38 GW) 50D which operates according to the T.38 mode protocol.

In this network configuration, the facsimile apparatus 10A can perform G3 facsimile communications with the facsimile apparatus 10C according to the virtual voice mode via the IP network 40 and the gateway 50C by means of the first communication unit.

The facsimile apparatus 10A can perform the G3 facsimile communications with the facsimile apparatus 10D according to T.38 mode via the IP network 40 and the gateway 50D by means of the second communication unit.

The facsimile apparatus 10A can use the first communication unit or the second communication unit to perform the facsimile communications with the facsimile apparatus 10B over the IP network 40 according to the virtual voice mode or the T.38 mode.

But, for the facsimile communications between the facsimile apparatus 10A and the facsimile apparatus 10B, the second communication unit (T.38 mode) having communication quality superior to the first communication unit (virtual voice mode) is selected by selective call control by selective call control section 131 to be described later so to conduct the T.38 mode facsimile communications.

When the facsimile apparatus 10A is used to call a destination terminal in the network environment shown in FIG. 2, selection of the first or second communication unit depends on, for example, the control made by the selective call control section 131 disposed in the system control section 13.

For example, the selective call control section 131 selects the first communication unit to send a first facsimile call to a destination terminal and conducts selective call control depending on whether the destination terminal has the T.38 mode communication capability so to conduct facsimile communications by using the first communication unit or to temporarily suspend the session and select the second communication unit again to send out.

For the selective call control, timing of judging the destination terminal's communication capability is considered to be when the session with the destination terminal is established or when the communication procedure of the facsimile protocol is started.

Based on that, a communication operation of the facsimile apparatus 10A under the network environment shown in FIG. 2 will be described.

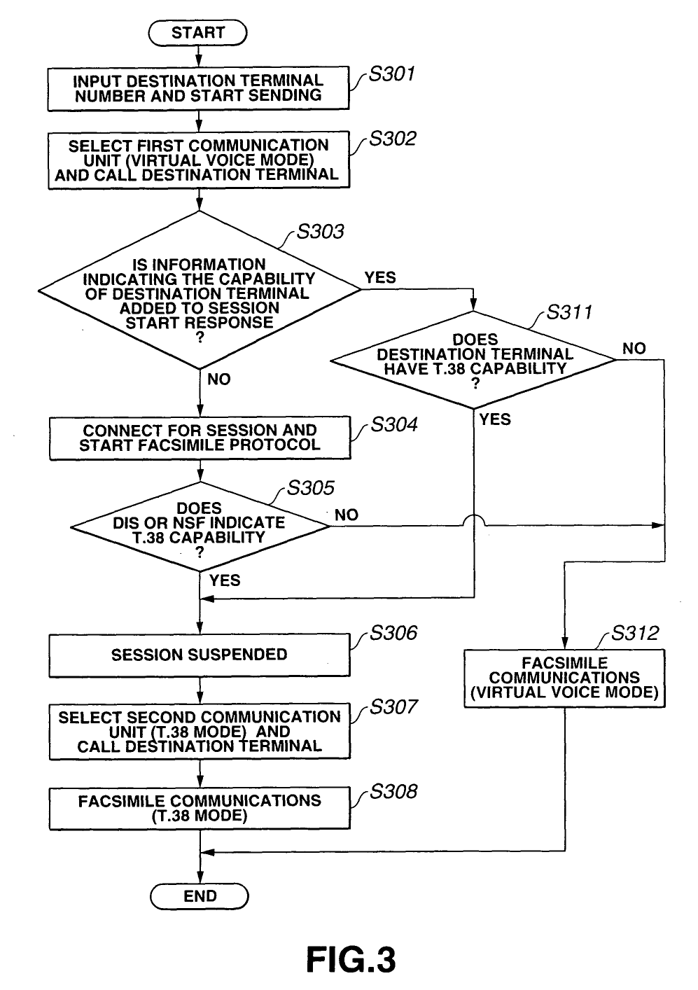

FIG. 3 is a flow chart showing a processing operation of the facsimile apparatus 10A (facsimile apparatus 10-1 of FIG. 1) according to the first embodiment.

In the facsimile apparatus 10A, when the user operates the operation/display section 17 to input a telephone number of a destination terminal so to start sending (step S301), the selective call control section 131 within the system control section 13 controls to select the virtual voice-mode first communication unit so to call a destination terminal (step S302).

Specifically, the selective call control section 131 gives instructions to the session connection control section 27 to start the session with the destination terminal.

When the session is started, the session connection control section 27 receives a response signal (session start response) from the destination terminal having a session and gives the session start response signal to the selective call control section 131.

The session target differs depending on a destination terminal to be called. For example, when the destination terminal is the facsimile apparatus 10C (see FIG. 2), the session target is the gateway 50C, and when the destination terminal is the facsimile apparatus 10D (see FIG. 2), the session target is the gateway 50D.

When the destination terminal is the facsimile apparatus 10B, the session target becomes the session connection control section 27 of the facsimile apparatus 10B (see FIG. 1).

Such session targets receive the session connection request from the facsimile apparatus 10A, add information indicating the communication capability of the facsimile apparatus under control (the destination terminal of this time) and send a session start response to the session requesting source (session connection control section 27 of the facsimile apparatus 10A).

In response to the session connection request, for example, the gateway 50C adds information indicating that the final destination terminal, the facsimile apparatus 10C, has communication capability compatible with the G3 FAX only and sends a session start response.

And, in response to the above session connection request, the gateway 50D adds information indicating that the final destination terminal, the facsimile apparatus 10D, has the communication capability compatible with the T.38 mode and sends a session start response.

In response to the session connection request, the facsimile apparatus 10B adds information indicating that the own facsimile apparatus 101B has the communication capability compatible with the T.38 mode and the communication capability compatible with the virtual voice mode and sends back a session start response.

For the notice of the communication capability from the session target, it is not limited to give a notice about the communication capability in the session connection stage (the communication capability is added to the session start response in response to the session connection request and sent), but the communication capability may be added after the session establishment to a particular communication procedure signal (DIS, NSF, etc.) in the stage proceeded to the facsimile protocol and sent.

The selective call control section 131, which has received a session start response from the session connection control section 27, checks whether information indicating the capability of the destination terminal is added to the session start response (step S303).

Here, when information indicating the capability of the destination terminal has not been added to the session start response (No in step S303), the selective call control section 131 establishes a session with the session target and starts a facsimile communication procedure (protocol) with the pertinent facsimile apparatus (step S304).

With the facsimile protocol being utilized, the first communication unit has a G3 facsimile communication procedure signal as an IP packet, send it to the destination facsimile apparatus over the IP network 40, and process to take a communication procedure signal from the IP packet received from the destination facsimile apparatus over the IP network 40.

And, when the facsimile control procedure is in progress, DIS or NSF indicating the capability is received from the destination facsimile apparatus, and the received DIS or NSF is given to the selective call control section 131.

The selective call control section 131 analyzes the DIS or NSF input from the first communication unit to judge whether the destination facsimile apparatus has the T. 38 mode communication capability (step S305).

When the destination facsimile apparatus (e.g., facsimile apparatus 10B or 10D) has the T.38 mode communication capability (YES in step S305), the selective call control section 131 temporarily suspends the session (step S306) and controls to select the T.38 mode second communication unit to call the destination terminal (step S307).

Then, the T.38 mode facsimile communications with the destination facsimile apparatus are executed according to a prescribed communication protocol.

By the T.38 mode facsimile communications, the T38 control section 24 in the second communication unit uses a protocol called as IFT to put a facsimile signal on the IP packet and sends to a receiving gateway (e.g., 50D).

The receiving gateway modulates the facsimile signal in the IP packet again to convert into the G3 facsimile analog signal and sends to a final address, e.g., the facsimile apparatus 10D.

During the above series of processing, when information indicating the capability of the destination terminal has been added to the session start response in the step S303 (YES in step S303), the selective call control section 131 analyzes the information and judges whether the destination terminal has the T.38 mode communication capability (step S311).

When the destination terminal has the T.38 mode communication capability (YES in step S311), the selective call control section 131 temporarily suspends the session (step S306), selects the T.38 mode second communication unit to call the destination terminal (step S307) and conducts T.38 mode facsimile communications with the destination facsimile apparatus.

Meanwhile, when the destination facsimile apparatus (e.g., facsimile apparatus 10C) does not have the T.38 mode communication capability (NO in step S311), the system control section 13 controls the first communication unit selected at the time of initial calling to conduct the virtual voice mode facsimile communications with the destination facsimile apparatus (e.g., 10C) (step S312).

Thus, the facsimile apparatus 10-1 according to the first embodiment is provided with the virtual voice mode facsimile communication unit comprised of the communication image processing section 18A, the T30 control section 19A, the MODEM 20, the voice encoding/decoding section 21, the real-time transfer control section 22 and the TCP/UDP/IP control section 25 (the first communication unit: see FIG. 1).

By configuring as described above, the facsimile apparatus 10-1 can realize the virtual voice-mode facsimile communications with a conventional facsimile apparatus, which is connected to the IP network via the VoIP gateway, without having an external adapter or an IP telephone terminal having an adapter function.

And, the facsimile apparatus 10-1 having the virtual voice-mode facsimile communication unit within it does not require an adapter or an IP telephone terminal with adapter functions. Thus, the cost of the facsimile system can be reduced by the const of that, and the configuration can be simplified.

The facsimile apparatus 10-1 is provided with, in addition to the virtual voice-mode communication unit (the first communication unit), the T.38 mode second communication unit, which is comprised of the T38 control section 24, the T30 control section 19B and the communication image processing section 18B, connected to the TCP/UDP/IP protocol control section 25 of the first communication unit and the communication unit selection unit (system control section 13) for selecting the first or second communication unit. Therefore, the conventional facsimile apparatus and the first communication unit can be used to make the virtual voice-mode facsimile communications, and the facsimile apparatus compatible with T.38 and the second communication unit can be used to make the T.38 mode facsimile communications.

And, in the facsimile apparatus 10-1, the first communication unit, which is comprised of the communication image processing section 18A, the T30 control section 19A, the MODEM 20, the voice encoding/decoding section 21, the real-time transfer control section 22 and the TCP/UDP/IP control section 25, and the second communication unit, which is comprised of the communication image processing section 18B, the T30 control section 19B, the T38 control section 24 and the TCP/UDP/IP control section 25, can share the TCP/UDP/IP control section 25 as shown in FIG. 1. Thus, the configuration can be simplified, and the cost can be reduced.

From the viewpoint of simplification of the configuration and further enhancement of the cost reducing effect, it is effective to configure the individual modules other than the TCP/UDP/IP control section 25, which is possessed by the first communication unit and the second communication unit, as a single common module as described in the second embodiment to be described later.

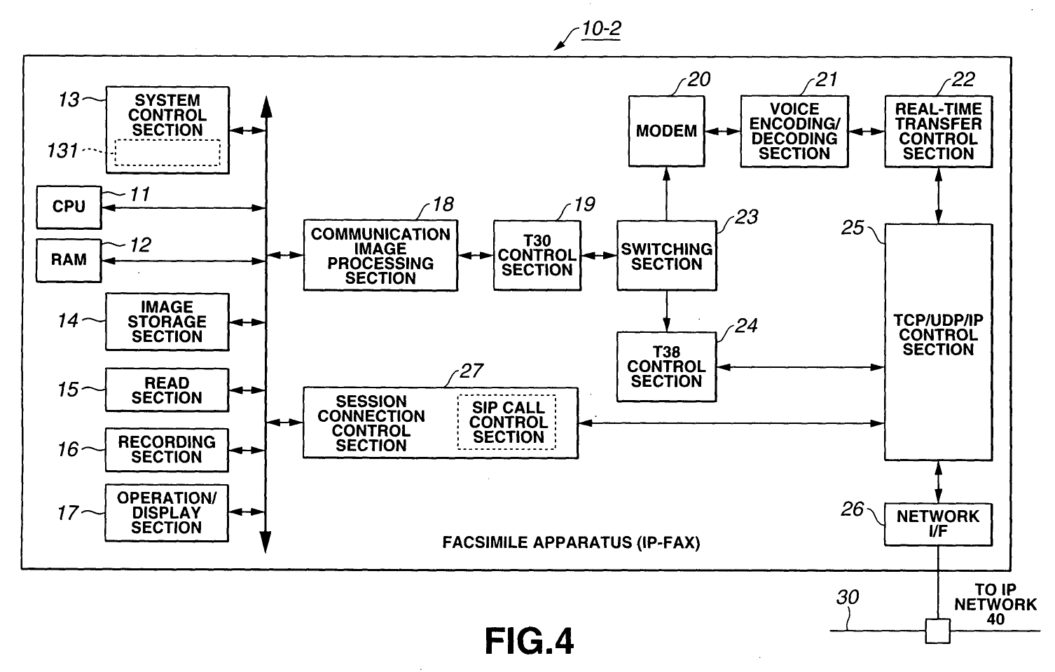

FIG. 4 is a block diagram showing a configuration of facsimile apparatus 10-2 according to the second embodiment.

In the facsimile apparatus 10-2, the CPU 11, the RAM 12, the system control section 13, the image storage section 14, the read section 15, the recording section 16, the operation/display section 17, the MODEM 20, the voice encoding/decoding section 21, the real-time transfer control section 22, the TCP/UDP/IP control section 25, the network I/F 26 and the session connection control section 27 are the same as those of the facsimile apparatus 10-1 according to the first embodiment.

The communication image processing section 18 and the T30 control section 19 are similar to the communication image processing sections (18A, 18B) and the T30 control sections (19A, 19B) of the facsimile apparatus 10-1 according to the first embodiment.

Besides, switching section 23 for selectively switching the connection between the T30 control section 19 and the MODEM 20 or the T38 control section 24 is disposed among the T30 control section 19, the MODEM 20 and the T38 control section 24.

The facsimile apparatus 10-2 can switch the switching section 23 to selectively form a communication unit, which is comprised of the communication image processing section 18, the T30 control section 19, the switching section 23, the MODEM 20, the voice encoding/decoding section 21, the real-time transfer control section 22 and the TCP/UDP/IP control section 25, and a communication unit, which is comprised of the communication image processing section 18, the T30 control section 19, the switching section 23, the T38 control section 24 and the TCP/UDP/IP control section 25.

The former communication unit corresponds to the virtual voice mode facsimile communication unit (the first communication unit) of the facsimile apparatus 10-1 according to the first embodiment, and the latter communication unit corresponds to the T.38 mode facsimile communication unit (the second communication unit) of the same facsimile apparatus 10-1.

Specifically, the facsimile apparatus 10-2 according to the second embodiment has the communication image processing sections 18A, 18B and the T30 control sections 19A, 19B, which are disposed for each of the first communication unit and the second communication unit in the facsimile apparatus 10-1 according to the first embodiment, configured as a single module (communication image processing section 18 and T30 control section 19).

Thus, two systems were required for the communication image processing sections and the T30 control sections in the first embodiment, but only one system is sufficient in the second embodiment. And, the configuration can be simplified, and the equipment cost reducing effect can be improved further more.

The operation of the facsimile apparatus 10-2 according to the second embodiment is the same as that of the facsimile apparatus 10-1 according to the first embodiment except that the first communication unit and the second communication unit are selectively switched by the selective call control section 131 which controls to switch the switching section 23.

Therefore, the facsimile apparatus 10-2 can make virtual voice mode facsimile communications in a state connected to the LAN 30 without having an external adapter or an IP telephone terminal with adapter functions.

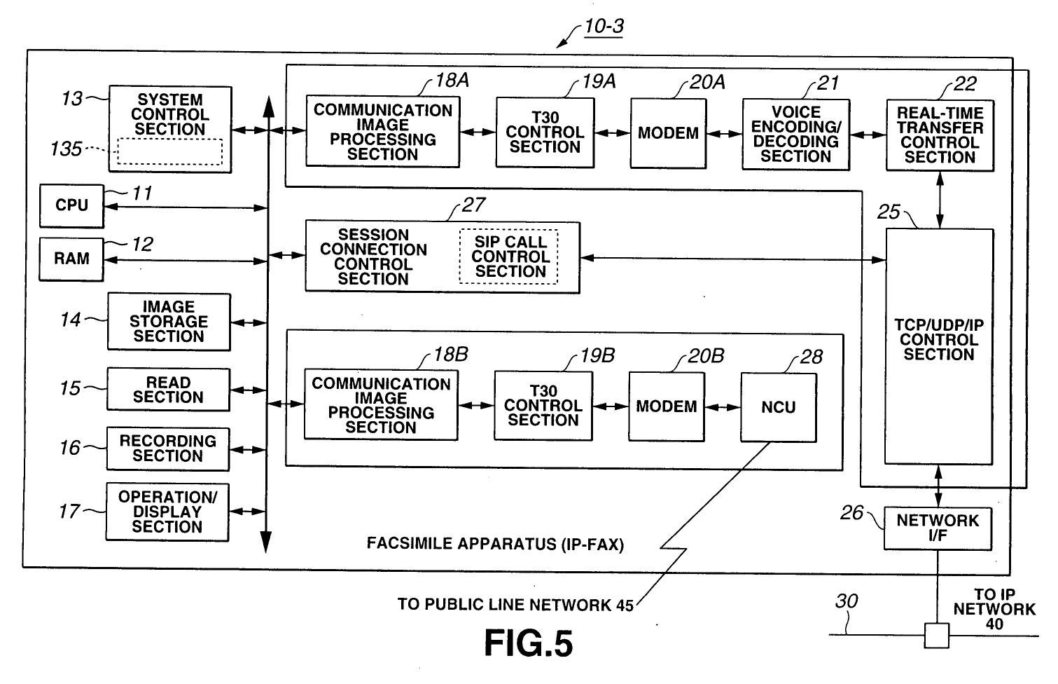

FIG. 5 is a block diagram showing a functional configuration of the facsimile apparatus 10-3 according to the third embodiment of the invention.

In the configuration of the facsimile apparatus 10-3, the CPU 11, the RAM 12, the image storage section 14, the read section 15, the recording section 16, the operation/display section 17, the network I/F 26 and the session connection control section 27 are the same as those of the facsimile apparatus 10-1 according to the first embodiment.

And, the portion, which is comprised of the communication image processing section 18A, the T30 control section 19A, MODEM 20A, the voice encoding/decoding section 21, the real-time transfer control section 22 and the TCP/UDP/IP control section 25, forms a virtual voice mode facsimile communication unit (hereinafter called the IP network communication unit).

The IP network communication unit is equivalent to, for example, the first communication unit of the facsimile apparatus 10-1 according to the first embodiment, and conduct virtual voice facsimile communications (G3) through the same signal processing as that described in the first embodiment over the IP network 40.

The facsimile apparatus 10-3 according to this embodiment is provided with the communication image processing section 18B which performs processing such as a resolution change, a paper size change and a code rule change of the image data according to the ability of the other end at the time of sending image data, the T30 control section 19B which controls the T.30 facsimile protocol according to the ITU-T recommendation, facsimile modem (MODEM) 20B which modulates/demodulates the facsimile signal, and network control section (NCU) 28 which controls the connection with the public line network.

The portion, which is comprised of the communication image processing section 18B, the T30 control section 19B, the MODEM 20B and the NCU 28, forms a conventional G3 mode facsimile communication unit (hereinafter called the public line network communication unit) which performs G3 facsimile communications over public line network 45.

And, the system control section 13 of the facsimile apparatus 10-3 is provided with a communication unit selection control function which selects the IP network communication unit or the public line network communication unit to call a destination terminal.

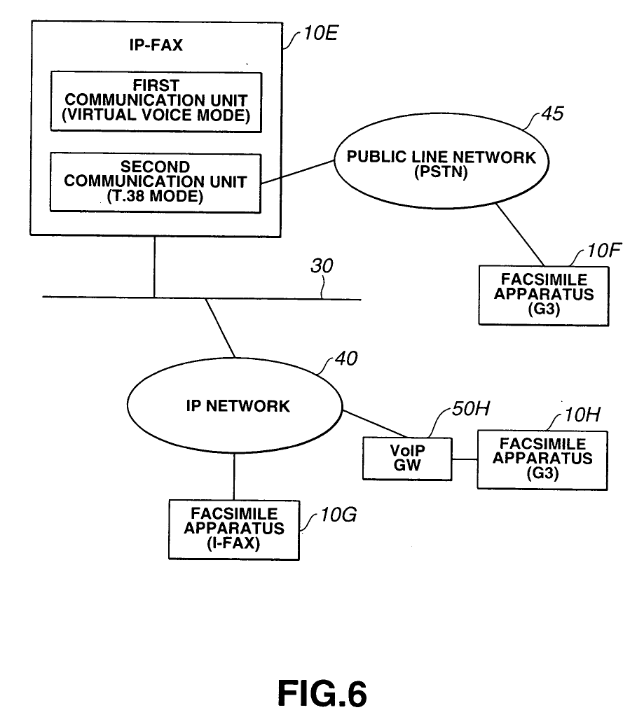

FIG. 6 is a diagram showing a configuration of the network on which the facsimile apparatus 10-3 according to the third embodiment is disposed.

In FIG. 6, facsimile apparatus 10E (Internet FAX: IP-FAX) corresponds to the facsimile apparatus 10-3 (see FIG. 5) according to the third embodiment.

The facsimile apparatus 10E is connected to a line of the public line network 45 via the NCU 28. Conventional (G3) facsimile apparatus 10F is connected to the public line network 45.

And, the facsimile apparatus 10E is connected to the IP network 40 via the LAN 30 by the network I/F 26.

Facsimile apparatus 10G (1′-FAX) having the same function as that of the facsimile apparatus 10E is connected to the IP network 40.

The conventional (G3) facsimile apparatus 10H is connected to the IP network 40 via gateway (VoIP GW) 50H using the VoIP technology.

By the above network configuration, the facsimile apparatus 10E can make virtual voice mode G3 facsimile communications with the facsimile apparatus 10H by the above-described IP network communication unit (virtual voice mode) through the IP network 40 and the gateway 50H.

And, the facsimile apparatus 10E can make virtual voice mode G3 facsimile communications with the facsimile apparatus 10G by the IP network communication unit through the IP network 40.

The facsimile apparatus 10E can make G3 facsimile communications with the facsimile apparatus 10F by the above-described public line network communication unit through the public line network 45.

Selection of the IP network communication unit or the public line network communication unit is left to, for example, the selective call control by the selective call control section 135 disposed in the system control section 13.

A specific example of the selective call control is that the selective call control section 135 selects a communication unit depending on whether the destination terminal to be called is an IP network terminal or a non-IP network terminal.

To realize it, for example, identification information on the IP network terminal which is disposed on the IP network 40 and can communicate by using the IP protocol is stored in an IP network terminal registration table disposed in the RAM 12.

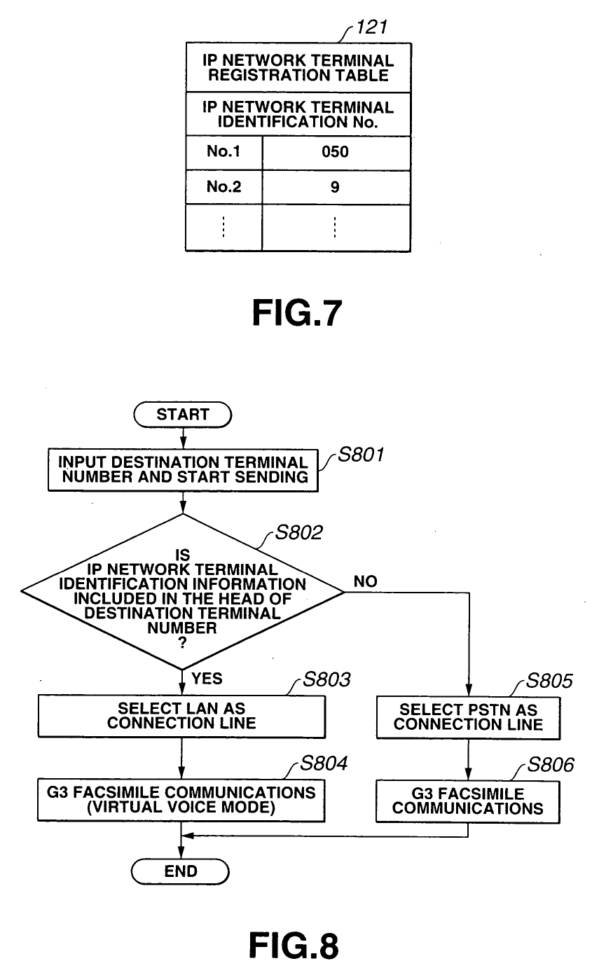

FIG. 7 is a diagram showing an example of the IP network terminal registration table 121. As shown in FIG. 7, among the numbers (IP telephone numbers) allotted to the IP network terminals in order to operate in the IP network 40, any desired digit number, such as “050” or “9” from the head is registered as IP terminal identification information in the IP network terminal registration table 121.

When a number of a destination terminal (destination terminal number) is input for facsimile transmission, the selective call control section 135 identifies whether the destination terminal is the IP network terminal or the non-IP network terminal depending on whether the head of the number contains digits registered in the IP network terminal registration table 121. When the destination terminal is the IP network terminal, the IP network communication unit is selected to control the origination of a call to the IP network 40, and when the destination terminal is the non-IP network terminal, the public line network communication unit is selected to control the origination of a call to the public line network 45.

FIG. 8 is a flow chart showing a communication operation of the facsimile apparatus 10E (facsimile apparatus 10-3 of FIG. 5) according to the third embodiment.

In the facsimile apparatus 10E, when the user operates the operation/display section 17 to input a number of a destination terminal (destination terminal number) and operates to start sending (step S801), the selective call control section 135 takes in the destination terminal number to compare it with the numbers registered in the IP network terminal registration table 121 so to check whether IP network terminal identification information is included in the head of the destination terminal number (step S802).

Here, when the IP network terminal identification information is included (YES in step S802), the selective call control section 135 selects the LAN 30 as a line to be connected (step S803) and controls to make a call from the network I/F 26 to the destination terminal via the IP network 40 by using the IP network communication unit (the communication image processing section 18A, the T30 control section 19A, the MODEM 20A, the voice encoding/decoding section 21, the real-time transfer control section 22 and the TCP/UDP/IP control section 25: see FIG. 1).

Then, when the session with the destination terminal is established by the session connection control section 27, the IP network communication unit uses the VoIP technology to conduct signal processing so to put the G3 facsimile communication procedure on the IP network 40 as it is and conducts virtual voice mode G3 facsimile communications with the destination terminal (step S804).

Meanwhile, when the head of the destination terminal number does not contain IP network terminal identification information (NO in step S802), the selective call control section 135 selects PSTN (public line network 45) as a line to be connected (step S805) and controls to use the public line network communication unit (the communication image processing section 18B, the T30 control section 19B and the MODEM 20B: see FIG. 1) so to make a call from the NCU 28 to the destination terminal over the public line network 45.

Then, when the session with the destination terminal is established by the session connection control section 27, the G3 facsimile communication procedure is performed by the public line network communication unit to conduct the G3 facsimile communications with the destination terminal over the public line network 45 (step S806).

Thus, the facsimile apparatus 10-3 according to the third embodiment is provided with a virtual voice mode facsimile communication unit (IP network communication unit: see FIG. 5) which are comprised of the communication image processing section 18A, the T3 0 control section 19A, the MODEM 20A, the voice encoding/decoding section 21, the real-time transfer control section 22 and the TCP/UDP/IP control section 25.

By configuring as described above, the facsimile apparatus 10-3 of the invention can also realize virtual voice mode facsimile communications over the LAN 30 without having an outside adapter or an IP telephone terminal having adapter functions.

And, as shown in FIG. 5, the facsimile apparatus 10-3 of this embodiment has, in addition to the above-described IP network communication unit, the G3 facsimile communication unit (public line network communication unit: see FIG. 5), which is comprised of the communication image processing section 18B, the T30 control section 19B, the MODEM 20B and the NCU 28 via the public line network and the communication unit selection control function, which selects the IP network communication unit or the public line network communication unit. Therefore, the IP network communication unit (virtual voice mode) can be used to make virtual voice mode facsimile communications with a facsimile apparatus connected to the IP network, and facsimile communications can be made with a facsimile apparatus connected to the public line network by using the public line network communication unit (conventional G3 mode).

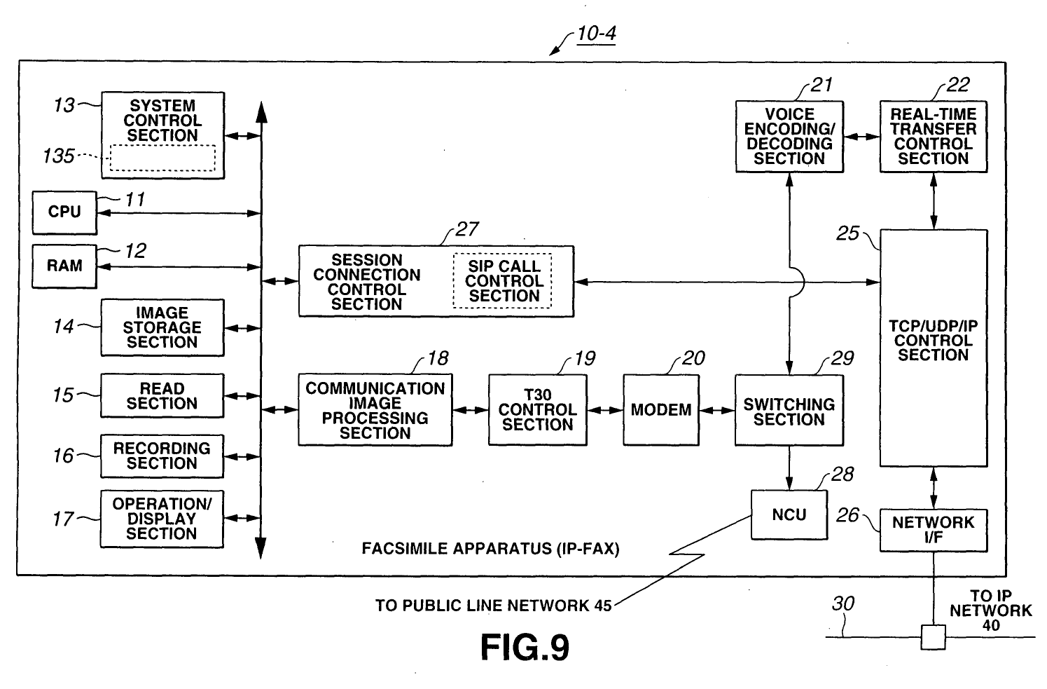

FIG. 9 is a block diagram showing a configuration of facsimile apparatus 10-4 according to the fourth embodiment.

In this facsimile apparatus 10-4, the CPU 11, the RAM 12, the system control section 13, the image storage section 14, the read section 15, the recording section 16, the operation/display section 17, the voice encoding/decoding section 21, the real-time transfer control section 22, the TCP/UDP/IP control section 25, the network I/F 26, the session connection control section 27 and the NCU 28 are equivalent to those of the facsimile apparatus 10-3 according to the third embodiment.

The communication image processing section 18, the T30 control section 19 and the MODEM 20 are equivalent to the communication image processing sections (18A, 18B), the T30 control sections (19A, 19B) and the MODEMs (20A, 20B) of the facsimile apparatus 10-3 according to the third embodiment.

Besides, switching section 29 which selectively switches the connection between the MODEM 20 and the voice encoding/decoding processing section 21 or the NCU 28 is disposed among the MODEM 20, the voice encoding/decoding processing section 21 and the NCU 28.

The facsimile apparatus 10-4 can selectively form a communication line, which is comprised of the communication image processing section 18, the T30 control section 19, the MODEM 20, the switching section 29, the voice encoding/decoding section 21, the real-time transfer control section 22 and the TCP/UDP/IP control section 25, and a communication line, which is comprised of the communication image processing section 18, the T30 control section 19, the MODEM 20, the switching section 29 and the NCU 28, by switching the switching section 29.

The former communication line is equivalent to the IP network communication unit of the facsimile apparatus 10-3 according to the third embodiment, and the latter communication line is equivalent to the public line network communication unit of the same facsimile apparatus 10-3.

Specifically, the facsimile apparatus 10-4 according to the fourth embodiment has the communication image processing sections 18A, 18B, the T30 control sections 19A, 19B and the MODEMs 20A, 20B, which are provided for each of the IP network communication unit and the public line network communication unit in the facsimile apparatus 10-3 according to the third embodiment, configured as a single module (the communication image processing section 18, the T30 control section 19 and the MODEM 20).

Thus, the communication image processing sections, the T30 control sections and the MODEMs which were required in two systems in the fourth embodiment are sufficient in one system in the second embodiment, and the configuration can be further simplified as compared with that of the facsimile apparatus 10-3, and the equipment cost can be reduced.

The operation of the facsimile apparatus 10-4 according to the fourth embodiment is the same as that of the facsimile apparatus 10-3 according to the third embodiment except that the selective call control section 135 controls to switch the switching section 29 so to selectively switch between the IP network communication unit and the public line network communication unit.

Therefore, the facsimile apparatus 10-3 can also make virtual voice mode facsimile communications in a state connected to the LAN 30 without adding an outside IP telephone terminal and, if necessary, can make G3 facsimile communications via the public line network 45.

It is to be understood that the present invention is not limited to the embodiments described above and also shown in the drawings but can be appropriately modified without departing from the spirit and scope thereof.

For example, as a component for the virtual voice mode communication unit, a voice speaking section (handset) which allows speaking by telephone by controlling to selectively connect virtual voice communication line may be provided.

Specifically, the voice speaking section may be connected between the MODEM 20 and the voice encoding/decoding section 21 of FIG. 1 and FIG. 4, between the voice encoding/decoding section 21 and the NCU 28 of FIG. 5 and to the switching section 29 of FIG. 9.

In the above-described embodiments, the combination of the virtual voice mode and the T.38 mode or the virtual voice mode and the conventional G3 mode was used, but a combination of the virtual voice mode, the T.38 mode and the conventional G3 mode can also be realized.

According to the present invention, the second communication section, which is comprised of the T38 protocol control section to be connected to the TCP/UDP/IP protocol control section of the virtual voice mode communication unit (first communication section), the T38 facsimile protocol control section and the T38 communication image processing section, and a communication section selecting section for selecting the first or second communication section are further provided. Therefore, the conventional facsimile apparatus and the first communication section can be used to make the virtual voice mode facsimile communications, and the T.38 facsimile apparatus and the second communication section can be used to make the T.38 mode facsimile communications.

In this case, the first and second communication sections can commonly use the TCP/UDP/IP protocol control section and other inside modules to simplify the circuit configuration and to reduce the costs.

As described above, the present invention has also disposed the conventional facsimile communication unit which is comprised of the network control unit for controlling the connection to a public line network, the public line network facsimile modem, the public line network facsimile protocol control unit and the public line network communication image processing unit, and the communication unit selecting unit for selecting either of such communication unit in addition to the virtual voice mode communication unit. Therefore, virtual voice mode facsimile communications can be made with the facsimile apparatus connected to the IP network by using the above-described virtual voice mode communication unit, and facsimile communications can be made with the facsimile apparatus connected to the public line network by using the conventional facsimile communication unit.

In this case, the virtual voice mode communication unit and the conventional facsimile communication unit can have a simplified circuit configuration by sharing the inside modules such as the facsimile modem, the facsimile protocol control unit and the communication image processing unit, and the cost reduction can be made.

What is claimed is:

1. A facsimile apparatus for facsimile communications over an IP network, comprising:
a network interface that connects to the IP network via a LAN or a public line;
a TCP/UDP/IP protocol control unit that is connected to the network interface and controls an IP protocol and a TCP/UDP protocol;
a real-time transfer protocol control unit that is connected to the TCP/UDP/IP protocol control unit and controls a real-time transfer protocol;
a voice encoding/decoding unit that is connected to the real-time transfer protocol control unit and encodes and decodes a voice signal;
a facsimile modem that is connected to the voice encoding/decoding unit and modulates and demodulates a facsimile signal;
a first T30 protocol control unit that is connected to the facsimile modem and controls a T.30 facsimile protocol;
a first communication image processing unit that is connected to the first T30 protocol control unit and conducts image processing of communication image data; and
an image storage unit that is connected to the communication image processing unit and stores a read image or image data received from a network; wherein:
real-time facsimile communications of a virtual voice-mode are conducted with a conventional facsimile apparatus via the IP network.

2. The facsimile apparatus according to claim 1, further comprising:
a T38 protocol control unit that is connected to the TCP/UDP/IP protocol control unit and controls a T.38 protocol;
a second T30 protocol control unit that is connected to the T38 protocol control unit and controls a T.30 facsimile protocol;
a second communication image processing unit that is connected between the second T30 protocol control unit and the image storage unit and conducts image processing of communication image data; and
a communication unit selecting unit that selects either of a first communication unit comprising the TCP/UDP/IP protocol control unit, the real-time transfer protocol control unit, the voice encoding/decoding unit, the facsimile modem, the first T30 protocol control unit and the communication image processing unit, or a second communication unit comprising the TCP/UDP/P protocol control unit, the T38 protocol control unit, the second T30 protocol control unit and the second communication image processing unit, wherein:
a conventional facsimile apparatus and the first communication unit are used to conduct the real-time facsimile communications, and a facsimile apparatus for T.38 and the second communication unit are used to conduct the real-time facsimile communications.

3. The facsimile apparatus according to claim 2, wherein:
the first T30 protocol control unit and the second T30 protocol control unit are configured by a shared protocol control unit, and
a switching unit is provided to selectively switch a connection of the shared protocol control unit with the facsimile modem or with the T38 protocol control unit.

4. The facsimile apparatus according to claim 2, further comprising:
a selective call control unit that first selects the first communication unit and call a destination terminal to judge whether the destination terminal has T.38 mode communication capability, and when the destination terminal has the T.38 mode communication capability, temporarily suspends the session and selects the second communication unit to call the destination terminal.

5. The facsimile apparatus according to claim 4, wherein it is judged whether the destination terminal has the T.38 mode communication capability in a stage of establishment of a session in response to the first call by the first communication unit.

6. The facsimile apparatus according to claim 4, wherein it is judged whether the destination terminal has the T.38 mode communication capability in a stage shifted to a facsimile protocol after the establishment of a session according to the first call by the first communication unit.

7. The facsimile apparatus according to claim 1, further comprising:
a network control unit that controls a connection to a public line;
a public line facsimile modem that is connected to the network control unit and modulates and demodulates a facsimile signal;
a public line facsimile protocol control unit that is connected to the public line facsimile modem and controls the T.30 facsimile protocol;
a public line communication image processing unit that is connected between the public line facsimile protocol control unit and the image storage unit and conducts image processing of communication image data; and
a communication unit selecting unit that selects either of the first communication unit comprising the TCP/UDP/IP protocol control unit, the real-time transfer protocol control unit, the voice encoding/decoding unit, the facsimile modem, the first T30 protocol control unit and the communication image processing unit, or the second communication unit comprising the network control unit, the public line facsimile modern, the public line facsimile protocol control unit and the public line communication image processing unit, wherein:
a facsimile apparatus connected to the IP network and the first communication unit are used to conduct communications, and a facsimile apparatus connected to the public line and the second communication unit are used to conduct communications.

8. The facsimile apparatus according to claim 7, wherein:
the facsimile modem and the public line facsimile modem are configured by a shared facsimile modem, and
a switching unit is provided to selectively switch a connection of the shared facsimile modem with the voice encoding/decoding unit or with the network control unit.

9. The facsimile apparatus according to claim 7, further comprising:
a destination terminal number input unit for inputting a destination terminal number;
an IP network terminal identification number storage unit that stores identification numbers used to identify IP network terminals; and
a selective call control unit that compares an input number with the identification numbers stored in the IP network terminal identification number storage unit when the destination terminal number is input to judge whether the destination terminal is an IP network terminal, and when the destination terminal is the IP network terminal, selects the first communication unit to call the destination terminal, and when the destination terminal is not the IP network terminal, selects the second communication unit to call the destination.

10. A facsimile apparatus for facsimile communications over an IP network, comprising:
a network interface that connects to the IP network over a LAN or a public line;
a TCP/UDP/IP protocol control unit that is connected to the network interface and controls an IP protocol and a TCP/UDP protocol;
a real-time transfer protocol control unit that is connected to the TCP/UDP/IP protocol control unit and controls a real-time transfer protocol;
a voice encoding/decoding unit that is connected to the real-time transfer protocol control unit and encodes and decodes a voice signal;
a facsimile modem that is connected to the voice encoding/decoding unit and modulates and demodulates a facsimile signal;
a facsimile protocol control unit that is connected to the facsimile modem and controls a T.30 facsimile protocol;
a communication image processing unit that is connected to the facsimile protocol control unit and conducts image processing of communication image data; and
an image storage unit that is connected to the communication image processing unit and stores a read image or image data received from a network; wherein:
real-time facsimile communications of a virtual voice mode are conducted with a conventional facsimile apparatus connected to the IP network over a VoIP gateway.

11. The facsimile apparatus according to claim 3, wherein the first communication image processing unit and the second communication image processing unit are configured by a shared communication image processing unit.

12. The facsimile apparatus according to claim 8, wherein the first T30 protocol control unit and the public line facsimile protocol control unit are configured by a shared protocol control unit, and the first communication image processing unit and the public line communication image processing unit are configured by a shared communication image processing unit.
